(19) United States
(12) Patent Application Publication
(10) Pub. No.: US 2017/0060272 A1
(43) Pub. Date: Mar. 2, 2017

(54) COMBINED ACTIVATION MECHANISM OF RETRACTABLE MARKER AND POWER STATUS FOR AN ELECTRONIC PEN

(71) Applicant: Livescribe Inc., Oakland, CA (US)

(72) Inventors: Christopher Wheaton, San Francisco, CA (US); Chi Kin Benjamin Leung, San Jose, CA (US); Gregory Robert Cerny, Palo Alto, CA (US); Kyle Aya Naydo, Mountain View, CA (US)

(21) Appl. No.: 15/144,587

(22) Filed: May 2, 2016

Related U.S. Application Data
(63) Continuation of application No. 14/523,845, filed on Oct. 25, 2014, now abandoned.
(60) Provisional application No. 61/895,877, filed on Oct. 25, 2013.

(51) Int. Cl. G06F 3/038; B43K 29/00; B43K 24/06; G06F 3/0354; B43K 1/00

(52) U.S. Cl. CPC G06F 3/0383; G06F 3/03545; B43K 1/00; B43K 24/06; B43K 29/003

(57) ABSTRACT

An electronic smart pen is disclosed that comprises a housing with a twist ring and a marker that is configured to be in an exposed state or in a retracted state. In the exposed state a tip of the marker is exposed from the housing, while the retracted state has the tip being enclosed by the housing. The smart pen also comprises an internal power switch that toggles the electronics of the smart pen between an on-state and an off-state. Rotating the twist ring provides a combined mechanism to move the marker from the retracted state to the exposed state, while also toggling the power switch from the off-state to the on-state so that the marker is automatically extended when the pen is turned on.

### CROSS REFERENCE TO RELATED APPLICATIONS

This application is a continuation of U.S. patent application Ser. No. 14/523,845, filed on Oct. 25, 2014, which claims the benefit of Provisional Application No. 61/895,877, filed on Oct. 25, 2013, each of which are incorporated herein by reference.

### BACKGROUND

1. Technical Field

The disclosure relates generally to a hardware configuration of a smart pen, and more particularly to a combined activation mechanism for controlling a retractable marker and power status of the smart pen.

2. Description of the Related Art

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). The smart pen computing environment can also collect contextual content (such as recorded audio), which can be replayed in the digital domain in conjunction with viewing the captured writing. The smart pen can therefore provide an enriched note taking experience for users by providing both the convenience of operating in the paper domain and the functionality and flexibility associated with digital environments. In addition, a smart pen can function as a regular pen for writing notes on paper by using ink from a marker contained within the pen's housing.

### SUMMARY

The described embodiments include an efficient method and apparatus of exposing or retracting a tip of a marker that is part of a sensor carriage assembly of an electronic smart pen when the device is in use or when writing and stroke capture are completed, respectively. In addition, the method and apparatus activates or deactivates the power status mechanism of the smart pen, i.e. turns the pen on or off, when the marker is exposed or retracted, respectively.

One embodiment includes an electronic smart pen that comprises a housing, an electronics assembly and a power switch that are both internal to the housing, a marker that is at least partially enclosed within the housing, and a combined activation mechanism that is switchable between a first state and a second state. The marker also has a tip to produce marks on a writing surface and is movable between an exposed state and a retracted state. In the exposed state the tip of the marker is exposed from the housing, whereas the tip of the marker is substantially retracted within the housing when the marker is in the retracted state. Furthermore, the power switch toggles the electronics assembly of the smart pen between an on-state and an off-state. The combined activation mechanism, when placed in the first state, causes the marker to move to the exposed state and the power switch to place the electronics assembly in the on-state. When placed in the second state it causes the marker to move to the retracted state and the power switch to place the electronics assembly in the off-state.

In some embodiments, the combined activation mechanism comprises a twist ring that is accessible externally to the housing. The twist ring is switchable between the first state and a second state by twisting the twist ring about a longitudinal axis of the housing.

In other embodiments, when the smart pen is not in use, a sensor carriage assembly carrying the marker and a camera module are retracted within the housing of the smart pen, and the pen is powered off In one embodiment, the smart pen is then turned on, by rotating a twist ring in the clockwise or counterclockwise direction, depending on the handedness of an attached twist cam system. The rotation of the twist ring also drives the attached twist cam system which in turn acts against a cam follower that is connected to the sensor carriage assembly, thereby moving the sensor carriage assembly forward and exposing the tip of the marker from a tip of the smart pen.

Once the user finishes writing, rotation of the twist ring in the opposite direction along with a spring inside the housing pushes the sensor carriage assembly and the marker tip back into the pen's housing, while also turning off the pen's electronics assembly.

### BRIEF DESCRIPTION OF THE DRAWINGS

FIGS. 1A, 1B, and 1C are diagrams of an embodiment of a smart pen showing an integrated module for activating a retractable marker and the pen's power status mechanism in combination.

FIG. 2 is an exploded three-dimensional diagram of an embodiment of a smart pen device for use in a pen-based computing system.

FIGS. 3A, 3B and 3C are diagrams of embodiments of a sensor carriage assembly for a smart pen.

FIGS. 4A and 4B are diagrams of embodiments of a main PCB assembly combined with a sensor carriage assembly for a smart pen.

FIGS. 5A and 5B are diagrams of embodiments showing the interior of a smart pen when the smart pen is in an off- or on-state, respectively.

FIGS. 6A, 6B, and 6C are diagrams of embodiments of the installation of twist cam parts and twist ring for a smart pen that act against a cam follower on a sensor carriage assembly to move the sensor carriage assembly forward or backwards during rotation of the twist ring.

FIG. 7 is a diagram of an embodiment of a smart pen-based computing system.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A smart pen device includes a combined activation mechanism that both controls a power state of the smart pen (e.g., on or off) and a retractable marker of the smart pen. The combined activation mechanism operates to turn the smart pen on and extend the retractable marker when the mechanism is placed in a first position, and operates to turn the smart pen off and retract the retractable marker when the mechanism is placed in a second position. Thus, the marker is automatically exposed when the pen is turned on and is automatically retracted when the pen is turned off.

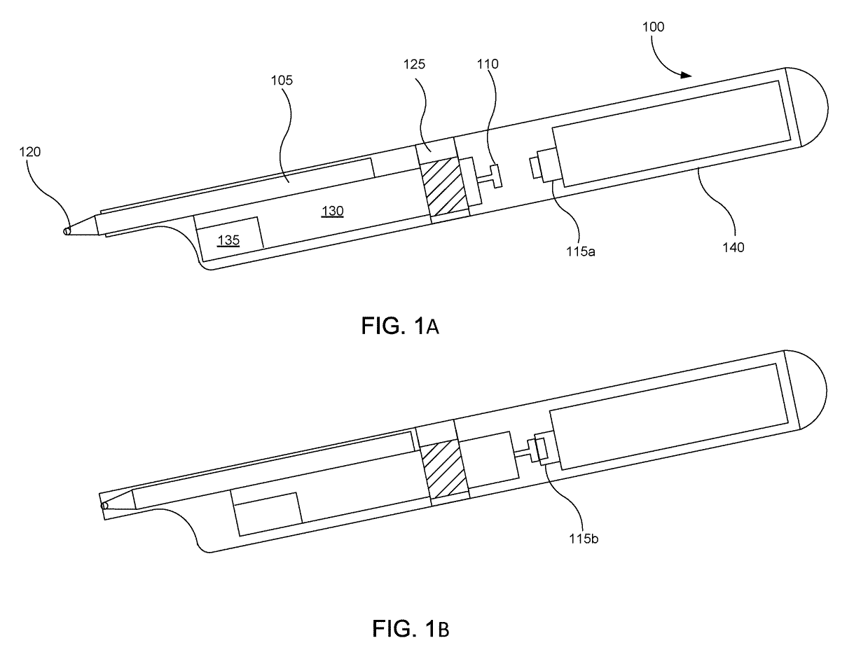

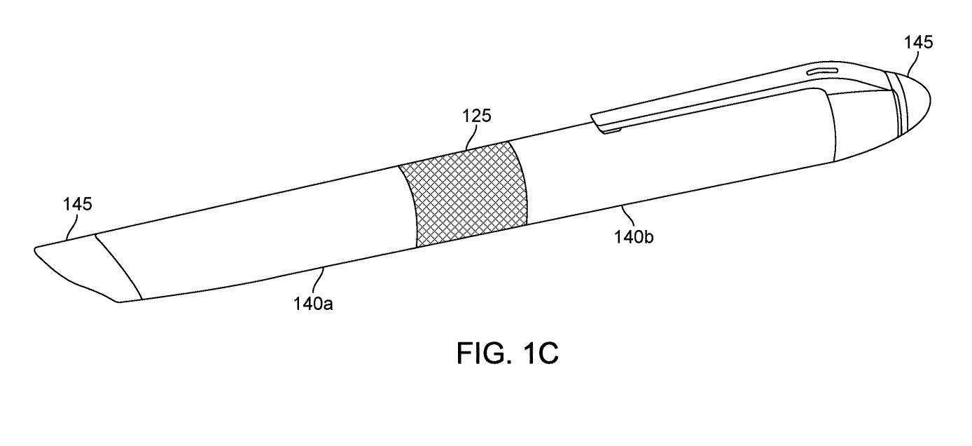

FIGS. 1A, 1B and 1C illustrate embodiments of a smart pen 100. The smart pen 100 comprises a retractable marker 105 having a tip 120, a sensor carriage assembly 130, a paddle 110, a power switch 115, a combined activation mechanism 125, and a housing 140. Other optional components of the smart pen 100 are omitted for clarity of description.

The combined activation mechanism 125 switches the smart pen 100 between an active state (illustrated in FIG. 1A) and an inactive state (illustrated in FIG. 1B). For example, in one embodiment, the combined activation mechanism 125 comprises a twist ring that when rotated causes the carriage assembly 130 including the imaging system 135 to move between the position of FIG. 1A and the position of FIG. 1B. The marker 105 having the tip 120 and the paddle 110 are attached at opposite ends of the carriage assembly 130. When the smart pen 100 is placed in the active state (FIG. 1A), the combined activation mechanism 125 causes the carriage assembly 130 to move to a position in which the marker's tip 120 is exposed from the pen's body. The paddle 110 at the opposite end of the carriage assembly 130 is disengaged from the power switch 115, which causes the power switch 115 to turn on internal electronics of the smart pen 100. In this active state the pen's battery is activated, as are the imaging system, the input/output device, the processor, and onboard memory. In some embodiments, the power switch turns on status lights, displays, microphones, speakers, and other components of the smart pen.

When the smart pen 100 is placed in the inactive state (FIG. 1B), the combined activation mechanism 125 causes the carriage assembly 130 to move to a position in which the tip 120 is substantially retracted within the pen's body. The paddle 110 engages the power switch 115, which causes the power switch 115 to turn off internal electronics of the smart pen 100. The components of the smart pen 100 are described in further detail below.

A perspective view of an embodiment of the fully assembled smart pen 100 is shown in FIG. 1C. The housing 140 encloses the combined activation mechanism 125 only exposing the twist ring to user access. The stylus tip 145 serves as protection for tip 120 of the marker and the sensor carriage assembly 130, and is used to write on or otherwise interact with devices or objects without leaving a physical ink mark by communicating with them wirelessly or via I/O port located at a capacitive cap 150. Examples of devices for use with the smart pen might include tablets, phones, personal digital assistants, interactive whiteboards, or other devices capable of touch-sensitive input. In some embodiment, the stylus tip may be used in place of or in combination with the marker 105.

### Components of a Smart Pen System

1. Assembly of Smart Pen System

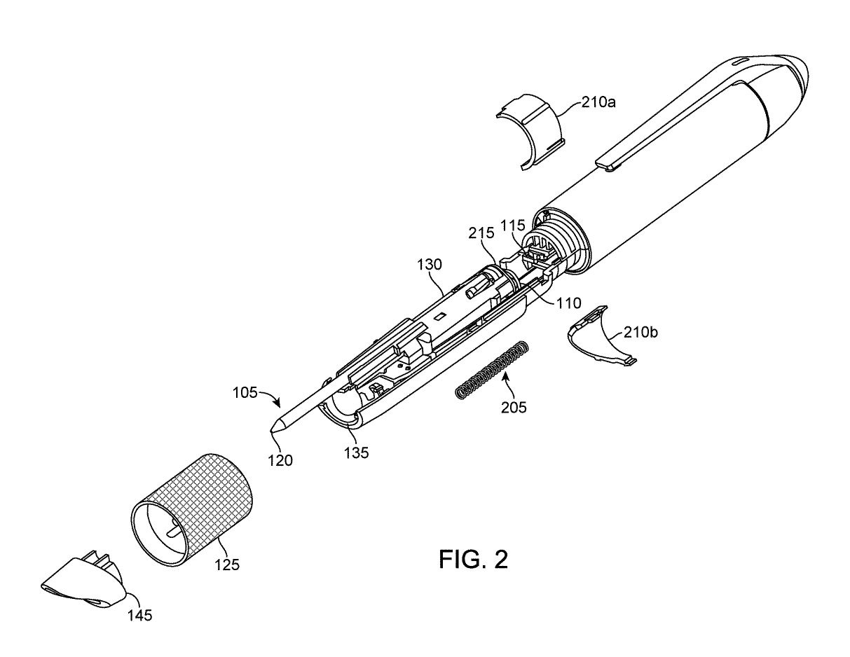

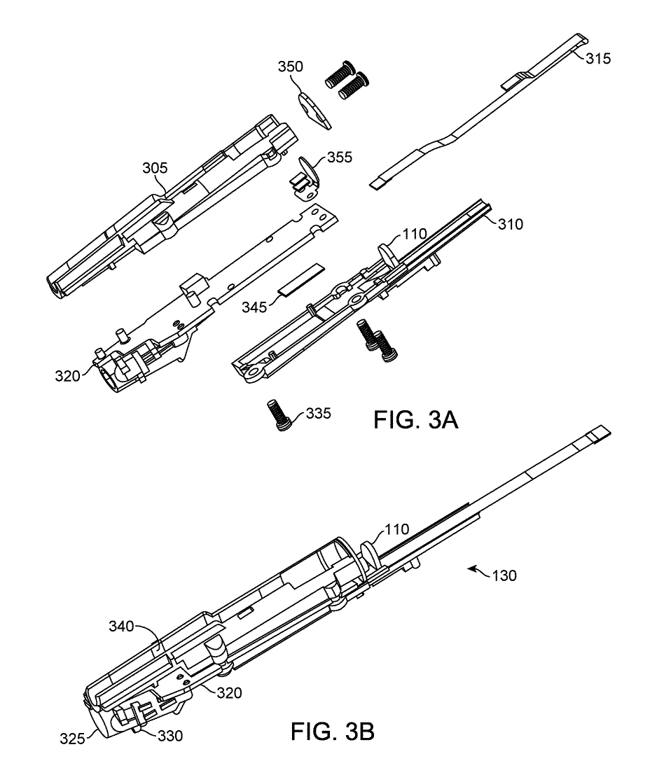

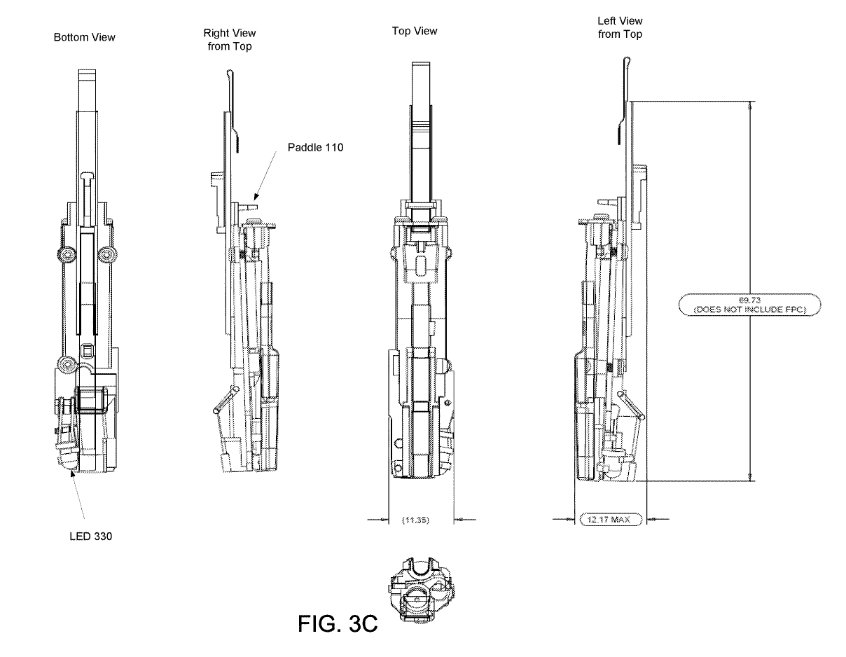

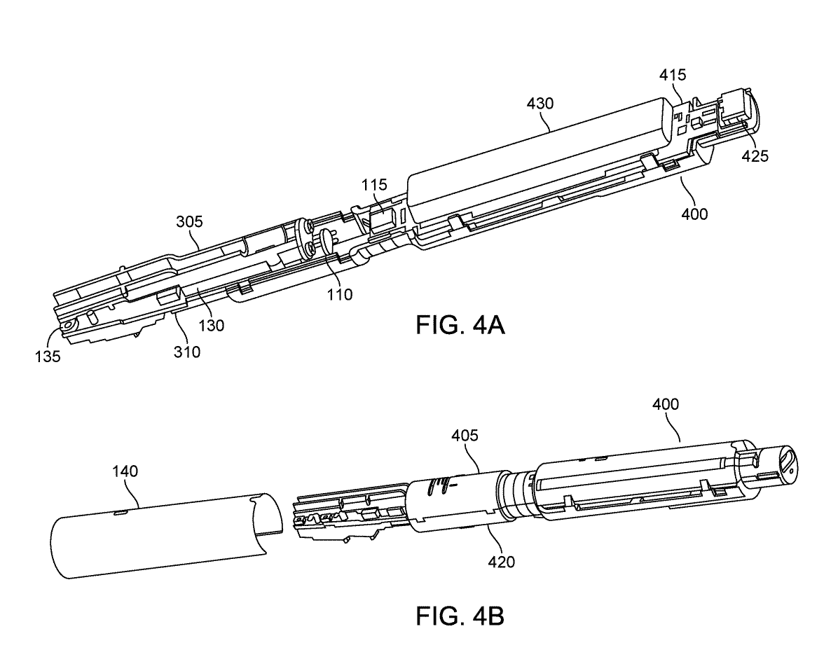

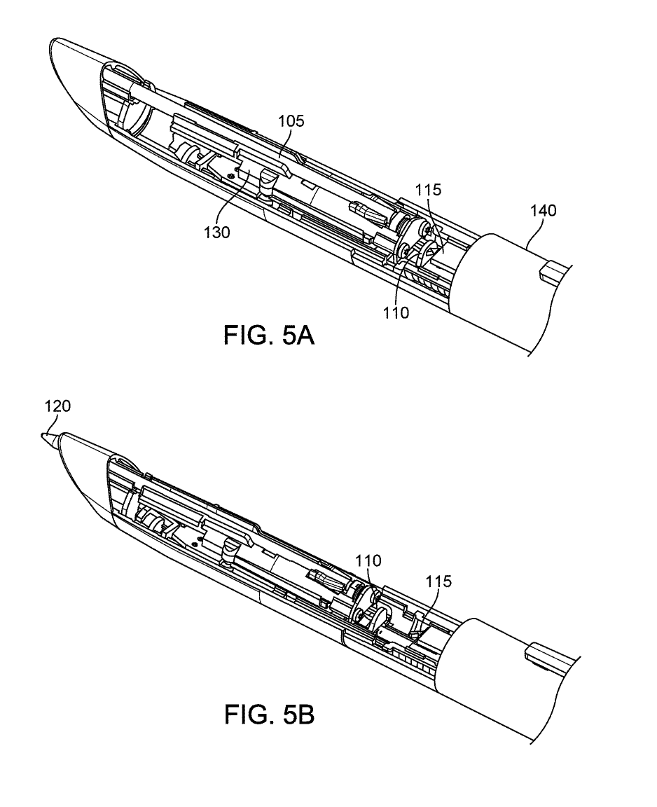

FIG. 2 illustrates a more detailed view of an embodiment of a smart pen 100 for use in a pen-based computing system including: a sensor carriage assembly 130 with a carriage spring 205, an imaging system 135, a paddle 110 for engaging an power (on/off) switch 115, a marker 105 affixed to the sensor carriage assembly 130 and having a tip 120, a twist cam system comprising twist cam parts 210a, 210b and a twist ring 125, and a stylus tip 145. The sensor carriage assembly 130 is described in further detail below with respect to FIGS. 3A, 3B and 3C, whereas a detailed description of the combined activation mechanism involving the paddle 110 and power switch 115 is provided with respect to FIGS. 4 and 5.

The marker 105 comprises any suitable marking mechanism, including any ink-based, graphite-based, ballpoint-based or stylus-type marking devices or any other devices that can be used for writing. The marker 105 is coupled to a pen down sensor 215, e.g. a force-sensing resistor® (FSR®), such as a pressure sensitive element to detect when the pen is pressed against a writing surface. In particular, a force-sensing resistor comprises material that alters its resistance when experiencing force or pressure. In an alternate embodiment, the marker 105 may make electronic marks on a writing surface using a paired projector or electronic display. In one embodiment, the marker 105 comprises an ink cartridge, but alternatively a stylus without ink may be used. The marker 105 further comprises a generally longitudinal extending tube having top and bottom ends with the top end of the tube connected with the ink cartridge and the bottom end of the tube connected to a tip 120 (e.g., a ballpoint pen tip). The longitudinal extending tube is configured to allow ink to flow within the tube from the ink cartridge to the ballpoint tip so that ink is delivered to the writing surface, when the tip 120 is pressed against the writing surface.

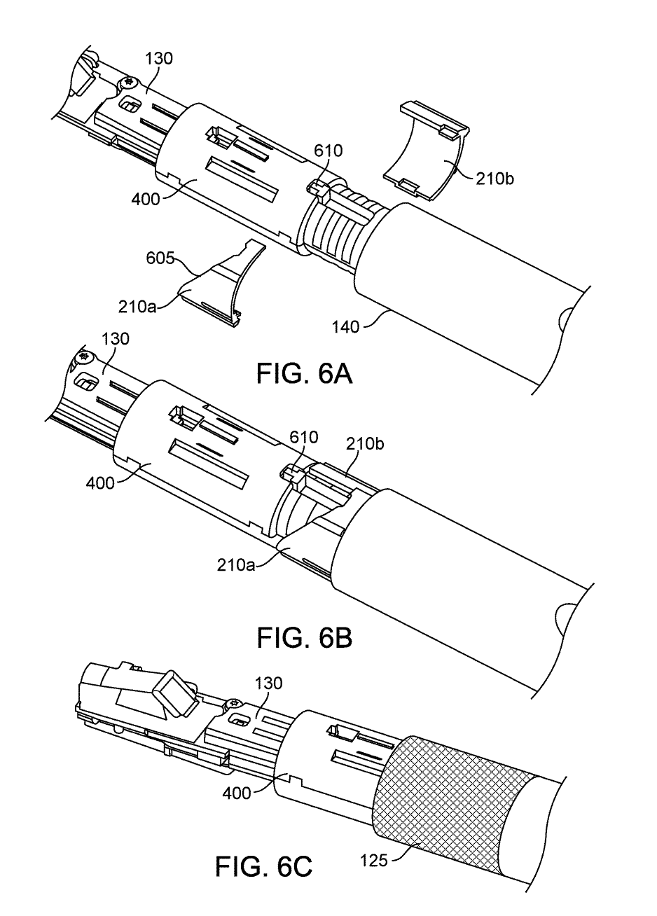

The twist cam parts 210 and twist ring 125 form parts of the combined activation mechanism for moving the marker 105 and the sensor carriage assembly 130 and toggling the power the smart pen between the on-state and off-state. Further detail of the combined activation mechanism involving the twist cam parts and ring are provided in the description of FIGS. 6A, 6B and 6C.

The imaging system 135 comprises optics and sensors for imaging an area of a surface near the marker 105, and be used to capture handwriting and gestures made with the smart pen 100. For example, the imaging system may include an infrared light source, e.g. a light-emitting diode (LED), which illuminates a writing surface in the general vicinity of the marker 105, where the writing surface includes an encoded pattern. By processing the image of the encoded pattern, the smart pen 100 can determine where the marker is in relation to the writing surface. The imaging system 135 then images the surface near the tip 120 of the marker 105 and captures a portion of a coded pattern in its field of view. In another embodiment, the imaging system can be used to scan and capture written content that already exists on the writing surface. This imaging system can be used, for example, to recognize handwritten or printed text, images, or controls on the writing surface.

2. Sensor Carriage Assembly

FIGS. 3A, 3B and 3C illustrate embodiments of the sensor carriage assembly 130 for a smart pen 100. In particular, FIG. 3A illustrates an exploded three-dimensional view of the sensor carriage assembly 130, whereas FIG. 3B shows a perspective view of the sensor carriage assembly 130. FIG. 3C illustrates bottom, right, top and left views and exemplary dimensions of the sensor carriage assembly 130. In the illustrated embodiments, the sensor carriage assembly 130 comprises a carriage top 305, a carriage bottom 310 including paddle 110, a flex print circuit (FPC) assembly 315, and a sensor PCB assembly 320. The sensor PCB assembly 320 includes a camera 325, an infra-red light-emitting diode (LED) 330, and a sensor comprising a FSR® backplate 350 and a FSR® assembly 355, which collectively make up imaging system 125. Additional components of the sensor carriage assembly 130 shown in FIG. 3 include screws 335, a marker holder 340, a FPC connector tape 345, which provide additional mechanical support structure for the smart pen 100. Other optional components of the sensor carriage assembly 130 are omitted from FIG. 3 for clarity of description including, for example, other electronic components attached to the sensor PCB assembly, and other components. In alternative embodiments, the sensor carriage assembly 130 may have fewer, additional, duplicate, or different components than those illustrated in FIG. 3.

When assembled, the sensor PCB assembly 320 and flex print circuit 315 are mounted between mounting posts of the carriage bottom 310 and carriage top 305. Screws 335 affix the carriage bottom 310 to the carriage top 305 thereby holding the sensor PCB assembly 320 and flex print circuit 315 in place. The camera 325 and the LED 330 of the imaging system 135 are connected with sensor PCB assembly 320 at a position close to the lower end (stylus tip side) of the assembly PCB 320, whereas the FPC assembly 315 extends beyond the upper end of the carriage bottom 310. When assembled, the marker 105 including the tip 120 is placed in a marker holder 340 on the upper side of the carriage top 310 at the lower end of the smart pen 100. In addition, the upper side of the carriage top 310 provides glide rails so that the sensor carriage assembly 210 can freely slide within the smart pen's enclosure.

The paddle 110 is connected with the upper end of carriage bottom 310. As described above, the paddle 110 is configured to engage the power (on/off) switch 115 (shown in FIGS. 1 and 2) to activate the smart pen's power status mechanism when the sensor carriage assembly 130 slides upwards towards the switch and presses against the switch, toggling the switch from an “on” to an “off” position as will be described in further detail below.

3. Main PCB Assembly and Sub Housing Assembly

FIGS. 4A-4B illustrate embodiments of the sensor carriage assembly 130 integrated with a sub housing assembly 400. In particular, FIG. 4A illustrates a perspective view of the sub housing assembly 400 and the sensor carriage assembly 130. This view lacks the sub housing top 405 to show the paddle 110 and power switch 115. FIG. 4B shows a perspective view of the sub housing assembly 400 with the sub housing top 405 and a housing 140 that encloses the sensor carriage assembly 130 after assembling the pen. In the illustrated embodiment, the sub housing assembly 400 comprises a main PCB assembly 415, a sub housing top 405, and a sub housing bottom 420. The main PCB assembly 415 comprises an electronics assembly and comprises the power switch 115 that turns the electronics on and off. The sub housing assembly 400 is structured to allow for the marker (not shown in FIGS. 4A-4B) and sensor carriage assembly 130 to slide with respect to the sub housing assembly 400, when the latter is fixed within the smart pen's body and with the sensor carriage assembly 130 partially resting within sub housing assembly 400. Sliding the marker and sensor carriage assembly 130 to a position where the carriage assembly 310 is fully retracted causes the paddle 110 to push against the power switch 115, engaging the switch and turning the electronics off. Sliding the marker and sensor carriage assembly 130 away from the power switch 115 disengages the paddle 110 from the power switch 115, causing the electronics of the smart pen to turn on.

The sub housing assembly 400 also comprises a processor (not shown), onboard memory (not shown), i.e. a non-transitory computer-readable storage medium, and a battery 430 (or any other suitable power source) enabling computing functionalities to be performed on the smart pen 100. The processor is coupled to the input and output devices (e.g., imaging system, pen down sensor, power status mechanism including the power switch 115, stylus tip, and a input/output (I/O) device using, e.g. a micro-USB connector 425 for wired I/O) as well as onboard memory and battery 430, thereby enabling applications running on the smart pen 100 to use those components. As a result, executable applications can be stored to a non-transitory computer-readable storage medium of the onboard memory and executed by the processor to carry out the various functions attributed to the smart pen 110 that are described herein.

The I/O device allows communication between the smart pen 100 and a network and/or the computing device. The I/O device may include a wired and/or a wireless communication interface such as, for example, a Bluetooth, Wi-Fi, WiMax, 3G, 4G, infrared, or ultrasonic interface, as well as any supporting antennas and power status mechanism. In addition, the connector 425 of the I/O device allows for charging the battery 430 of the smart pen.

4. Power Status Mechanism

The embodiments of FIGS. 5A-5B further illustrate the combined activation mechanism for the retractable marker 105 and the power status of the smart pen. In particular, FIG. 5A shows the smart pen in the second state (inactive) in which the paddle 110 engages the switch 115 to turn the pen's power “off” and the tip 120 of marker 105 is retracted within the pen's housing 140. In one embodiment, this is accomplished by mechanically coupling the paddle 110 to the sensor carriage assembly 130 that carries the marker 105 such that when the marker is retracted the paddle engages the switch, toggling the power off. In comparison, FIG. 5B shows the first state (active) of the smart pen, having the tip 120 of the marker 105 exposed from the pen's housing and the paddle 110 disengaged from the power switch 115, thereby switching the pen's power “on.” In some embodiments, the power switch may have multiple positions, each position toggling “on” a particular subset of the components in the smart pen.

5. Twist Cam System

FIGS. 6A-C illustrate embodiments of the installation of twist cam parts and twist ring as part of the combined activation mechanism for a smart pen. In particular, FIG. 6A shows an exploded three-dimensional perspective view of the smart pen including the movable sensor carriage assembly 130, the housing 140 partially enclosing the fixed sub-housing assembly 400, and twist cam parts 210 including a first twist cam part 210a and a second twist cam part 210b. FIG. 6B illustrates a perspective view of the smart pen with the twist cam parts affixed to the sub-housing assembly 400, while FIG. 6C is a view of the smart pen that shows the twist ring 125 assembled over the twist cam parts.

In the shown embodiments, the twist ring 125 has grooves on the inside that engage both twist cam parts 210 such that when rotating the twist ring 125 around the longitudinal axis of the smart pen the twist cam parts 210 follow the rotational motion of the twist ring 125. The twist cam parts 210 are set within a cutout of the sub housing assembly such that they can rotate about the assembly. A first twist cam part 210a has a sloped edge 605 which engages a cam follower 610 of the carriage assembly 130. When both cam parts 210 are rotated around the pen's axis (e.g., in a clockwise direction viewed from the top of the pen), the sloped edge 605 of the first cam part pushes the cam follower 610 such that the rotational motion of the twist ring 125 translates to a linear motion of the carriage assembly 130. In turn, the sensor carriage assembly 130 separates from sub housing assembly 400. Thus, the rotating motion of the twist ring moves the sensor carriage assembly away from the sub housing assembly and exposes the marker tip (not shown) from the smart pen's housing. In one embodiment, the motion of the cam follower 610 is opposed by a spring (not shown) that exerts a force towards the twist cam. This causes the cam follower (and the sensor carriage assembly) to follow the sloped edge of the first twist cam part when the twist ring twists the first cam part in the opposite direction (e.g., a counterclockwise direction when viewed from the top of the pen), thus retracting the carriage assembly back into the housing.

In one embodiment, this twist cam mechanism is coupled with the above described combined activation mechanism for the retractable marker and the power status of the smart pen. Rotation of the twist ring thus controls whether the smart pen is in the first (active) or second (inactive) state.

### Overview of a Computing System for a Smart Pen

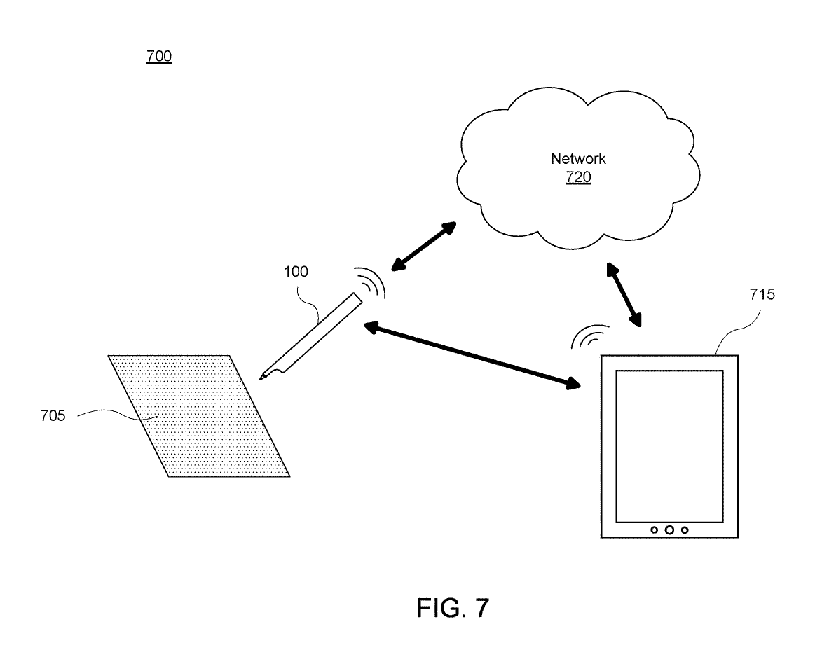

FIG. 7 illustrates an embodiment of a pen-based computing system 700 providing an example use for the smart pen 100 described herein. The pen-based computing system comprises a writing surface 705, a smart pen 100, a computing device 715, a network 720, and a cloud server 725. In alternative embodiments, different or additional devices may be present such as, for example, additional smart pens 100, writing surfaces 705, and computing devices 715 (or one or more device may be absent).

The smart pen 100 is an electronic device that digitally captures interactions with the writing surface 705 (e.g., writing gestures and/or control inputs). The smart pen 100 is communicatively coupled to the computing device 715 either directly or via the network 720. The captured writing gestures and/or control inputs may be transferred from the smart pen 100 to the computing device 715 (e.g., either in real time or at a later time) for use with one or more applications executing on the computing device 715. Furthermore, digital data and/or control inputs may be communicated from the computing device 715 to the smart pen 100 (either in real time or as an offline process) for use with an application executing on the smart pen 100. Commands may similarly be communicated from the smart pen 100 to the computing device 715 for use with an application executing on the computing device 715. The cloud server 725 provides remote storage and/or application services that can be utilized by the smart pen 100 and/or the computing device 715. The pen-based computing system 700 thus enables a wide variety of applications that combine user interactions in both paper and digital domains.

In one embodiment, the smart pen 100 comprises a writing instrument (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 100 on the writing surface 705 as the user would with a conventional pen. During the operation, the smart pen 100 digitally captures the writing gestures made on the writing surface 705 and stores electronic representations of the writing gestures. The captured writing gestures have both spatial components and a time component. In one embodiment, the smart pen 100 captures position samples (i.e., coordinate information) of the smart pen 100 with respect to the writing surface 705 at various sample times and stores the captured position information together with the timing information of each sample. The captured writing gestures may furthermore include identifying information associated with the particular writing surface 705 such as, for example, identifying information of a particular page in a particular notebook so as to distinguish between data captured with different writing surfaces 705.

In one embodiment, the smart pen 100 is capable of outputting visual and/or audio information. The smart pen 100 may furthermore execute one or more software applications that control various outputs and operations of the smart pen 100 in response to different inputs.

In one embodiment, the writing surface 705 comprises a sheet of paper (or any other suitable material that can be written upon) and is encoded with a pattern (e.g., a dot pattern) that can be sensed by the smart pen 100. In another embodiment, the writing surface 705 comprises electronic paper, or e-paper, or may comprise a display screen of an electronic device (e.g., a tablet, a projector), which may be the computing device 715 or a different device. Movement of the smart pen 100 may be sensed, for example, via optical sensing of the smart pen 100, via motion sensing of the smart pen 100, via touch sensing of the writing surface 705, via a fiducial marking, or other suitable means.

In an embodiment, the computing device 715 additionally captures contextual data while the smart pen 100 captures written gestures. In an alternate embodiment, the smart pen 100 or a combination of a smart pen 100 and a computing device 715 captures contextual data. The contextual data may include audio and/or video from an audio/visual source (e. g., the surrounding room). Contextual data may also include, for example, user interactions with the computing device 715 (e.g. documents, web pages, emails, and other concurrently viewed content), information gathered by the computing device 715 (e.g., geospatial location), and synchronization information (e.g., cue points) associated with time-based content (e.g., audio or video) being viewed or recorded on the computing device 715. The computing device 715 stores the contextual data synchronized in time with the captured writing gestures (i.e., the relative timing information between the captured written gestures and contextual data is preserved). Furthermore, in an alternate embodiment, some or all of the contextual data can be stored on the smart pen 100 instead of, or in addition to, being stored on the computing device 715.

The computing device 715 may comprise, for example, a tablet computing device, a mobile phone, a laptop or desktop computer, or other electronic device (e.g., another smart pen 100). The computing device 715 may execute one or more applications that can be used in conjunction with the smart pen 100. For example, written gestures and contextual data captured by the smart pen 100 may be transferred to the computing system 715 for storage, playback, editing, and/or further processing. Additionally, data and or control signals available on the computing device 715 may be transferred to the smart pen 100. Furthermore, applications executing concurrently on the smart pen 100 and the computing device 715 may enable a variety of different real-time interactions between the smart pen 100 and the computing device 715. For example, interactions between the smart pen 100 and the writing surface 705 may be used to provide input to an application executing on the computing device 715 (or vice versa). Additionally, the captured stroke data may be displayed in real-time in the computing device 715 as it is being captured by the smart pen 100.

### Additional Considerations and Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. An electronic smart pen comprising:
a housing;
an electronics assembly internal to the housing;
a marker at least partially enclosed within the housing, the marker having a tip to produce marks on a writing surface, the marker movable between an exposed state and a retracted state, wherein the tip of the marker is exposed from the housing when the marker is in the exposed state, and wherein the tip of the marker is substantially retracted within the housing when the marker is in the retracted state;
a power switch internal to the housing, the power switch to toggle the electronics assembly of the smart pen between an on-state and an off-state;
a combined activation mechanism switchable between a first state and a second state, wherein the combined activation mechanism when placed in the first state causes the marker to move to the exposed state and causes the power switch to place the electronics assembly in the on-state, and wherein the combined activation mechanism when placed in the second state causes the marker to move to the retracted state and causes the power switch to place the electronics assembly in the off-state.

2. The electronic smart pen of claim 1, wherein the combined activation mechanism comprises:
a twist ring accessible externally to the housing, the twist ring switchable between the first state and a second state by twisting the twist ring about a longitudinal axis of the housing.

3. The electronic smart pen of claim 2, wherein the combined activation mechanism further comprises:
a cam follower attached to the marker;
one or more twist cam parts to apply a force to the cam follower when rotated in a first direction, the twist cam parts coupled to the twist ring to twist about the longitudinal axis together with the twist ring, the twist cam parts structured to convert rotational motion of the twist cam parts to linear motion of the cam follower, thereby causing the marker to move between the retracted state and the exposed state.

4. The electronic smart pen of claim 2, further comprising:
a spring to apply a force to the marker to push the marker to the retracted state when the one or more twist cam parts are rotated in a second direction opposite the first direction.

5. The electronic smart pen of claim 3, wherein the twist ring comprises:
a rubber piece that engages the combined activation mechanism by frictional force acting on the plurality of twist cam parts.

6. The electronic smart pen of claim 1 further comprising:
a marker assembly to hold the marker and an imaging system; and
a paddle that is physically coupled to the marker assembly, the paddle to toggle the power switch to place the electronics assembly in the off-state when the marker moves to the retracted state.

7. The electronic smart pen of claim 1, wherein the marker deposits ink on a writing surface when the tip of the marker is pressed the writing surface.
